(19) United States
(12) Patent Application Publication
(10) Pub. No.: US 2013/0339257 A1
(43) Pub. Date: Dec. 19, 2013

(54) METHOD OF PREPARING PATENT APPLICATIONS FOR MULTIPLE CUSTOMERS IN A NETWORK OF INDEPENDENT PATENT AGENTS

(71) Applicant: Harold W. Milton, JR., Bloomfield Hills, MI (US)

(72) Inventor: Harold W. Milton, JR., Bloomfield Hills, MI (US)

(21) Appl. No.: 13/936,885

(22) Filed: Jul. 8, 2013

Related U.S. Application Data
(63) Continuation-in-part of application No. 13/526,845, filed on Jun. 19, 2012, now abandoned.

(51) Int. Cl. G06Q 50/18; G06Q 10/10

(52) U.S. Cl. CPC G06Q 50/184; G06Q 10/10
USPC 705/310

(57) ABSTRACT

A data processing center contracts with a patent owner to prepare a patent application and then independently contracts with one of a plurality of independent contracting patent agents to prepare the patent application with a specific relationship between the sections of the patent application. A patent agent database contains a patent agent identification and subject matter classifications for patent applications by that contracting patent agent which is scanned for a match to avoid the same subject matter from two different customers being assigned to the same contract patent agent. The contract with the contract patent agent includes specific provisions regarding the relationship of the sections of a patent application and the completed patent application is graded by the center patent agent for conformance to the specific provisions of the preparation contract. The grading is stored with each contract patent agent in the contract patent agent database.

### CROSS REFERENCE TO RELATED APPLICATIONS

The present application is a continuation-in-part of co-pending U.S. application Ser. No. 13/526,845 entitled “A Method of Preparing Patent Applications for Multiple Customers in a Network of Independent Patent Agents” filed on Jun. 19, 2012.

### BACKGROUND OF THE INVENTION

1. Field of the Invention

A method of preparing patent applications for multiple customers in a network of independent patent agents.

2. Description of the Prior Art

A law firm typically includes at least one patent agent licensed by the United States Patent and Trademark Office (USPTO) and who operates a computer for providing patent applications for filing with the USPTO. That law firm frequently receives from a client/customer via the internet a request to prepare a patent application covering an invention for filing in the USPTO. Each client/customer is assigned a customer identification, e.g., a docket number, which is maintained on a computer each with an associated customer identification. The law firm makes an agreement with the client/customer to provide a patent application, which upon completion is forwarded to the client/customer.

### SUMMARY OF THE INVENTION

The subject invention is characterized by maintaining a contract patent agent database on a controller of a data processing center including a contract patent agent identification and maintaining the contract patent agents in the patent agent database as independent contractors in communication with the data processing center via the internet. A contract patent agent is selected from the patent agent database for preparing a patent application and a preparation contract is established between the data processing center and the selected contract patent agent wherein the contract includes specific provisions to require a specific relationship of content between the sections of the completed patent application while maintaining the contract patent agent and customer contractually independent of one another. The completed patent application is received from the selected contract patent agent before forwarding the patent application to the customer.

### ADVANTAGES OF THE INVENTION

Among the several advantages of the invention is the drafting of patent applications at a reduced cost and with a higher consistent quality. Patent agents generally work at lower rates than attorneys and eliminate substantial overhead costs when working over the internet from remote facilities, such as working from their residence. The quality of each patent application from each patent agent remains at a relatively high standard as all of the patent agents agree to the specific relationship of content between the sections of the patent application. This facilitates a standard for review to maintain the quality at a consistent level from patent application to patent application. Because the patent agents are independent contractors and independent of one another, there are many more choices in assigning the preparation of patent applications vis-à-vis the technology involved.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a block diagram of the specific elements of the enabling embodiment;

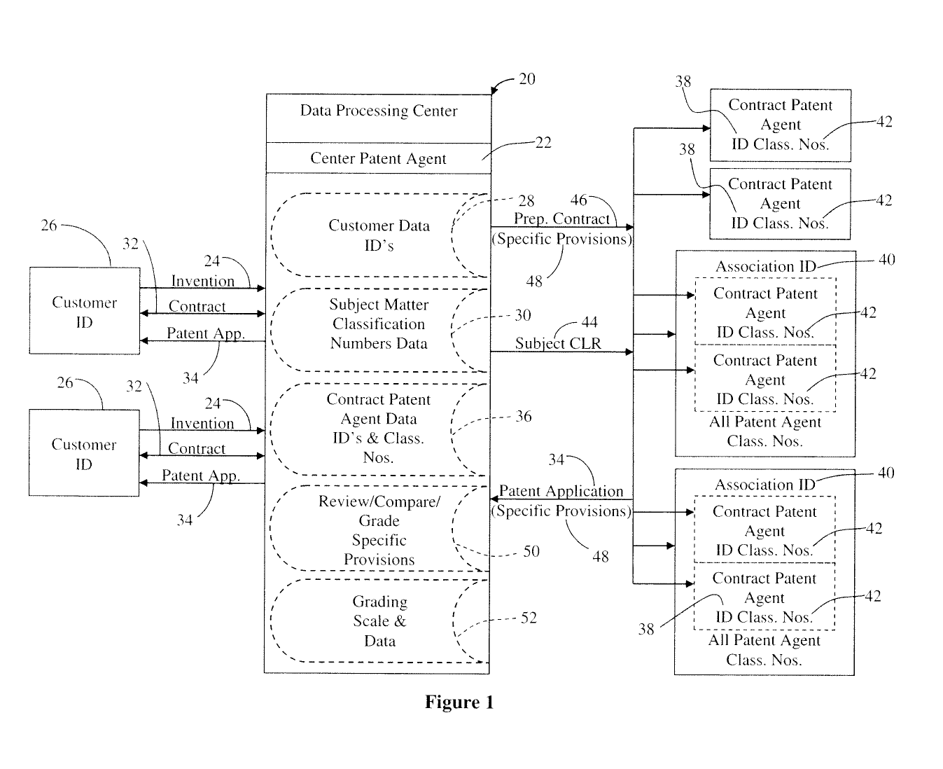

FIG. 2 is a flow chart illustrating of some of the steps of the enabling embodiment of the invention; and

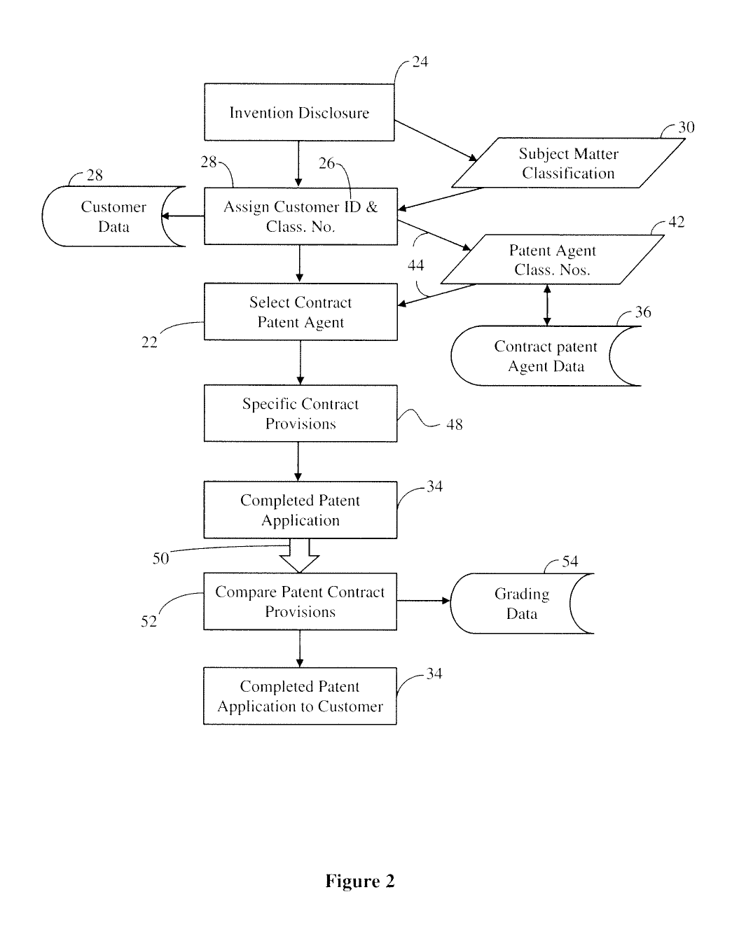

FIG. 3 is a block diagram of a data processing center of the enabling embodiment of the invention.

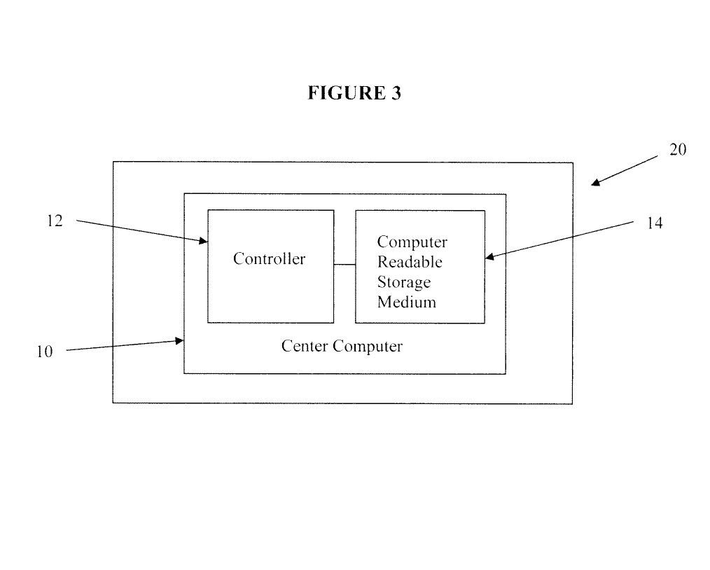

### DETAILED DESCRIPTION OF THE ENABLING EMBODIMENTS

The subject invention in the most specific description of the enabling embodiment involves a method of preparing patent applications for multiple customers via the internet by contract patent agents in independent business associations. Each contract patent agent preferably uses a computer program having a template embedded therein setting forth sections of a patent application including a prior art section designated Field of the Invention, Description of the Prior Art and a summary section designated SUMMARY OF THE INVENTION and a description designated DETAILED DESCRIPTION OF THE ENABLING EMBODIMENT and a claims section designated CLAIMS and equivalents thereof. Codes are embedded in the computer program for recognizing the coded phrase “characterized by” and any portion thereof for identifying and moving limitations in subparagraphs of an independent broad claim into different sections of the template and for automatically reconciling the preamble of an independent detailed picture claim with the Field of the Invention.

The method includes operating a data processing center 20 (generally indicated) having a center computer 10 including a controller 12 and a computer readable storage medium 14. The method also includes receiving patent applications for filing with the United States Patent and Trademark Office (USPTO) from at least one center patent agent 22 licensed by the USPTO. The center patent agent 22 has a Registration number from the USPTO to be licensed to represent inventors in communications with the USPTO. The data processing center 20 includes computer readable storage medium 14 for storage and manipulation and a controller 12 for inputting data and extracting data.

The process usually begins by receiving at the data processing center 20 from a customer via the internet a request for preparing a patent application covering an invention for filing in the USPTO. This usually occurs by receiving at the data processing center 20 from the customer via the internet an invention disclosure 24 describing the invention including identification of known prior art. The customer will usually be the inventor or the owner of the invention made by the inventor.

The controller 12 of the center computer 10 disposed at data processing center 20 reacts by generating a customer identification 26 or ID for each successive new customer and then storing and maintaining a customer database 28 in the computer readable storage medium 14. Put another way, the customer database 28 includes a stored list of customers each with the associated customer identification 26.

The generating of the customer identification 26 further includes the controller 12 disposed at the data processing center 20 accessing a patent office classification system 30 dividing technology by numbers into classes and sub-classes of technology and indicating the subject matter to be found in and excluded from a class and sub-class. This could be the USPTO classification system and/or the international classification system.

The method includes establishing a patent contract 32 between the customer and the data processing center 20 in which the data processing center 20 agrees to provide a patent application, usually at a fixed fee. Of course, the patent contract 32 is fulfilled by the data processing center 20 forwarding the completed patent application 34 to the customer.

However, the steps between entering the patent contract 32 and delivery of the completed patent application 34 are much more specific.

One such step is maintaining a contract patent agent database 36 by the controller 12 on the computer readable storage medium 14 including a contract patent agent identification 38 and an association identification 40 or ID for each contract patent agent to identify contract patent agents associated in and with the same business association. More specifically, the controller 12 stores and maintains the contract patent agents in the contract patent agent database 36 as independent contractors and in independent business associations and in communication with the data processing center 20 via the internet. The contract patent agents are not only independent of the data processing center 20, they are independent of one another, i.e., in independent business associations. Each of the patent agents may use a computer and a word processing program with the template therein for preparing a patent application.

The method includes generating and assigning by the controller (12) an initial subject matter classification number (Class. No.) to each invention disclosure 24 received from a customer and storing the initial subject matter classification number with the customer identification 26 in the computer readable storage medium 14. Also included is the step of storing a contract patent agent subject matter classification number 42 with each contract patent agent identification 38 in the contract patent agent database 36 for each patent application prepared by that contract patent agent for the data processing center 20. In order to separate contract patent agents by the business association from which they operate, the method may include the more specific step of storing a subject matter classification number with each business association identification 40 in the patent agent database for each patent application prepared by every contract patent agent identification 38 in the same business association of patent agents, i.e., the association subject matter classifications would include all of the contract patent agent subject matter classification numbers 42 of all of the contract patent agents in that association. This facilitates conducting a subject matter clearance 44 (CLR) for the selected contract patent agent by electronically scanning the patent agent identification and association identification 40 in the patent agent database by the controller 12 for a match between the initial subject matter subject matter classification number of the customer disclosure and all of the contract patent agent subject matter classification numbers 42 assigned to the contract patent agent and the contract patent agent's business association to avoid the same subject matter from two different customers being assigned to the same contract patent agent and to different contract patent agents in the same business association. Such a subject matter clearance 44 allows the selection of a contract patent agent from the contract patent agent database 36 for preparing a patent application, a contract patent agent that has no subject matter conflict either by subject matter personally worked on or subject matter worked on by another patent agent in the same business association.

Once the contract patent agent is selected, the method proceeds by establishing a preparation contract 46 between the data processing center 20 and the selected contract patent agent wherein the contract includes specific provisions 48 to provide the patent application at a fixed fee while maintaining the contract patent agent and customer contractually independent of one another. More specifically, the preparation contract 46 between the data processing center 20 and the selected contract patent agent is established with specific provisions 48 regarding a specific relationship of content between the sections of a patent application. The relationship of the sections in the enabling embodiment includes paraphrasing portions of certain claims into certain sections of the patent application whereby each section of the patent application is derived from or corresponds to a certain claim or portion thereof. Accordingly, the contract patent agent agrees and is required to operate a computer program to draft, or otherwise draft, a patent application based upon the invention disclosure 24 with the CLAIMS section of the template including a broad claim reciting a novel limitation in a subparagraph after the coded phrase “characterized by” with supporting old prior art limitations in subparagraphs before the coded phrase characterized by and successive claims dependent on the broad claim with each dependent claim reciting a novel limitation and an independent picture claim containing in subparagraphs all of the same verbiage used in the broad and dependent claims. The contract patent agent also agrees and is required to operate the computer program to copy, or otherwise copy, all of and only the sub-paragraphs of the picture claim into respective paragraphs the description section DETAILED DESCRIPTION OF THE ENABLING EMBODIMENT of the template and to operate the patent computer program to recognize the coded phrase characterized by and to copy only the supporting old limitations before the coded phrase of the broad claim into the section Description of the Prior Art of the template and to recognize the coded phrase characterized by and copy only a novel limitation after the coded phrase characterized by of the broad claim into the summary section SUMMARY OF THE INVENTION of the template. Put another way, the patent application prepared by the contract patent agent in accordance with the preparation contract will include a DETAILED DESCRIPTION OF THE ENABLING EMBODIMENT section which recites only the same language of the sub-paragraphs of the picture claim and a Description of the Prior Art section which recites only the same language of the supporting old limitations presented before the coded phrase of the broad claim and a SUMMARY OF THE INVENTION section which recites only the same language as the novel limitation presented after the coded phrase of the broad claim. No other additional language or omitted language should be present or absent in each of these sections of the patent application.

In response, the data processing center 20 receives the completed patent application 34 from the selected contract patent agent with a broad claim reciting a novel limitation in a subparagraph after the characterized by clause in the summary section with supporting old prior art limitations in subparagraphs before the characterized by clause in the prior art section and successive claims dependent on the broad claim with each dependent claim reciting a novel limitation and an independent picture claim containing all of the same verbiage used in the broad and dependent claims copied into the description section. The method proceeds by electronically reviewing 50 the completed patent application 34 using the controller 12 by electronically scanning and comparing the Description of the Prior Art section with the old limitations before the coded phrase in the broad claim and scanning and comparing the SUMMARY OF THE INVENTION section to the novel limitation after the coded phrase with the old limitations, as well as the more detailed review of scanning and comparing the DETAILED DESCRIPTION OF THE ENABLING EMBODIMENT to the picture claim. Put another way, the controller 12 and not a user at the data processing center, electronically scans and compares various sections of the completed patent application received from the contract patent agent to ensure the completed patent application complies with the specific provisions of the preparation contract. This electronic comparison can be completed in the same manner that document content can be compared between two versions of a document on a word processing program.

An electronic grading 52 of the completed application may facilitate a more intense quality control function. The electronic grading 52, which is also performed by the controller 12 and not a user at the data processing center 20, can occur simultaneously with the electronic reviewing 50 and includes determining a percentage of change or difference between the Specification of the completed patent application (i.e., Description of the Prior Art, SUMMARY OF THE INVENTION, and DETAILED DESCRIPTION OF THE ENABLING EMBODIMENT sections) and the claims of the completed patent application. More specifically, the electronic grading 52 preformed by the controller 12 determines a percentage of change or difference between (a) the DETAILED DESCRIPTION OF THE ENABLING EMBODIMENT section and the picture claim, (b) the Description of the Prior Art section and the supporting old prior art limitations presented in subparagraphs before the characterized by clause of the broad claim, and (c) the SUMMARY OF THE INVENTION section and the novel limitation presented in subparagraphs after the characterized by clause of the broad claim. For example, an electronic grading of 100% would result when (a) the DETAILED DESCRIPTION OF THE ENABLING EMBODIMENT section recites exactly the same verbiage, with no additional or no less verbiage, as the picture claim, (b) the Description of the Prior Art section recites exactly the same verbiage, with no additional or no less verbiage, as the supporting old prior art limitations presented in subparagraphs before the characterized by clause of the broad claim, and (c) the SUMMARY OF THE INVENTION section recites exactly the same verbiage, with no additional or no less verbiage, as the novel limitation presented in subparagraphs after the characterized by clause of the broad claim. A less than 100% electronic grading would result when differences are present between at least one of these sections and their respective claims of the completed patent application, as this relationship is described above. The electronic grading 52 can also include averaging the electronic grading percentage for each of (a), (b), and (c) recited above to arrive at a final electronic grade for the completed patent application.

In order to establish a more detailed quality control function and to maintain a consistent minimum standard of quality in the completed patent applications 34, the method may include establishing a predetermined scale for electronically grading 52 the patent application. For example, an electronic grading of 95-100% could be equivalent to an “A”, an electronic grading of 90-95% could be equivalent to a “B”, and electronic grading of 85-90% could be equivalent to a “C”, an electronic grading of 75-85% could be equivalent to a “D”, and an electronic grading of less than 75% could be equivalent to an “F”. Of course, any other predetermined scales for grading the patent application can be used without departing from the subject invention. As a result, the method may include electronically grading 52 in addition to reviewing 50 the completed patent application 34 from the selected contract patent agent by the center patent agent 22 for conformance to the specific provisions 48 of the preparation contract 46 regarding the sections of a patent application before forwarding the completed patent application 34 to the customer. Attendant to the electronically grading 52 will be storing the grading 52 for each completed patent application 34 with each contract patent agent in the contract patent agent database 36.

To remain current in subject matter clearances 44, the method may also include assigning a filing subject matter classification number for the completed patent application 34 from the contract patent agent and reconciling the initial subject matter classification number to agree with the filing subject matter.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the inventive novelty exercises its utility. In addition, the reference numerals in the claims are merely for convenience and are not to be read in any way as limiting.

What is claimed is:

1. A method for preparing patent applications for multiple customers in a network of independent patent agents using a data processing center (20) having a center computer (10) including a controller (12) and a computer readable storage medium (14) comprising;
storing a contract patent agent database (36) on the computer readable storage medium (14) of the center computer (10) including a contract patent agent identification (38) associated with each independent patent agent in the network of independent patent agents,
receiving at the data processing center (20) from a customer via the internet a request to prepare a patent application covering an invention disclosure describing an invention,
assigning the invention disclosure (24) received from the customer an initial subject matter classification number according to a patent office classification system (30) dividing technology by numbers into classes and sub-classes of technology and indicating the subject matter to be found in and excluded from a class and sub-class,
generating a customer identification (26) to each successive customer using the controller (12) disposed at the data processing center (20),
storing by the controller (12) the customer identification (26) and the initial subject matter classification number assigned to the invention disclosure in a customer database (28) stored on the computer readable storage medium (14),
selecting a contract patent agent from the contract patent agent database to prepare a patent application for the customer,
receiving the completed patent application (34) at the data processing center (20) from the selected contract patent agent,
forwarding the completed patent application to the customer,
storing by the controller (12) an agent subject matter classification number (42) in the patent agent database and with the contract patent agent identification (38) of the selected patent agent which corresponds to the initial subject matter classification number assigned to the invention disclosure associated with the completed patent application,
conducting a subject matter clearance (44) prior to selecting the contract patent agent, and
said conducting a subject matter clearance (44) includes electronically scanning and comparing using the controller (12) the initial subject matter classification number assigned to the invention disclosure and stored in the customer database (28) with each agent subject matter classification number (42) stored in the patent agent database of the computer readable memory to identify a match between the initial subject matter classification number and any one of the agent subject matter classification numbers (42) for avoiding the same subject matter from two different customers being assigned to the same contract patent agent.

2. A method as set forth in claim 1 further comprising;
establishing a preparation contract (32) between the data processing center (20) and the selected contract patent agent which includes specific provisions (48) to require a specific relationship of content between the sections of the completed patent application (34); and
electronically reviewing (50) the patent application received from the selected contract patent agent by the controller (12) to establish conformance to the specific provisions (48) of the preparation contract (46).

3. A method as set forth in claim 2 further comprising;
said establishing the specific provisions (48) in the preparation contract (46) includes establishing specific provisions (48) to require that a CLAIMS section of the completed patent application includes a broad claim reciting at least one concluding limitation in a subparagraph after a coded phrase “characterized by” with supporting limitations in subparagraphs before the coded phrase “characterized by” and successive claims dependent on the broad claim with each dependent claim reciting at least one additional limitation and an independent picture claim containing in subparagraphs all of the same verbiage used in the broad and dependent claims and a DETAILED DESCRIPTION OF THE ENABLING EMBODIMENT of the completed patent application including all of and only the same verbiage used in the subparagraphs of the independent picture claim and a Description of the Prior Art section of the completed patent application reciting only the supporting limitations of the broad claim and a SUMMARY OF THE INVENTION section of the completed patent application reciting only the at least one concluding limitation of the broad claim, and
said electronically reviewing (50) the completed patent application (34) to establish conformance with the specific provisions (48) of the preparation contract (46) includes:
electronically scanning and comparing by the controller (12) the Description of the Prior Art section of the completed patent application with the supporting limitations recited before the coded phrase “characterized by” in the broad claim of the CLAIMS section of the completed patent application to identify any differences therebetween,
electronically scanning and comparing by the controller (12) the SUMMARY OF THE INVENTION section of the completed patent application with the at least one concluding limitation recited in a subparagraph after the coded phrase “characterized by” in the broad claim of the CLAIMS section of the completed patent application to identify any differences therebetween, and
electronically scanning and comparing by the controller (12) the DETAILED DESCRIPTION OF THE ENABLING EMBODIMENT of the completed patent application with the independent picture claim in the CLAIMS section of the patent application to identify any differences therebetween.

4. A method as set forth in claim 3 further comprising;
electronically grading (52) the patent application received from the selected contract patent agent using the controller (12) based on (a) the differences identified between the Description of the Prior Art section of the completed patent application and the supporting limitations recited before the coded phrase “characterized by” in the broad claim of the CLAIMS section of the completed patent application and (b) the differences identified between SUMMARY OF THE INVENTION section of the completed patent application and the at least one concluding limitation recited in a subparagraph after the coded phrase “characterized by” in the broad claim of the CLAIMS section of the completed patent application and (c) the differences identified between the DETAILED DESCRIPTION OF THE ENABLING EMBODIMENT of the completed patent application and the independent picture claim in the CLAIMS section of the completed patent application.

5. A method as set forth in claim 4 wherein said electronic grading results in a grade of 100% when (a) no differences are identified between the Description of the Prior Art section of the completed patent application and the supporting limitations recited before the coded phrase “characterized by” in the broad claim of the CLAIMS section of the completed patent application and (b) no differences are identified between SUMMARY OF THE INVENTION section of the completed patent application and the at least one concluding limitation recited in a subparagraph after the coded phrase “characterized by” in the broad claim of the CLAIMS section of the completed patent application and (c) no differences are identified between the DETAILED DESCRIPTION OF THE ENABLING EMBODIMENT of the completed patent application and the independent picture claim in the CLAIMS section of the completed patent application.

6. A method as set forth in claim 4 wherein said electronic grading results in a grade of less than 100% when differences are identified between at least one of (a) the Description of the Prior Art section of the completed patent application and the supporting limitations recited before the coded phrase “characterized by” in the broad claim of the CLAIMS section of the completed patent application and (b) the SUMMARY OF THE INVENTION section of the completed patent application and the at least one concluding limitation recited in a subparagraph after the coded phrase “characterized by” in the broad claim of the CLAIMS section of the completed patent application and (c) the DETAILED DESCRIPTION OF THE ENABLING EMBODIMENT of the completed patent application and the independent picture claim in the CLAIMS section of the completed patent application.

7. A method as set forth in claim 4 further comprising storing the grading (52) and the identified differences for each completed patent application (34) in the contract patent agent database (36) and with the contract patent agent identification (38) associated with the selected contract patent agent.

8. A method as set forth in claim 1 further comprising;
storing an association identification (40) for each contract patent agent in the contract patent agent database (36) to identify contract patent agents associated in and with the same business association,
inserting a subject matter classification number with each business association identification (40) in the patent agent database for each patent application prepared by every contract patent agent identification (38) in the same business association of patent agents, and
said conducting the subject matter clearance (44) includes electronically comparing using the controller (12) the initial subject matter classification number assigned to the invention disclosure and stored in the customer database (28) with the association identification (40) stored in the patent agent database to identify a match between the initial subject matter subject matter classification number of the customer disclosure and all of the contract patent agent subject matter numbers assigned to the contract patent agent's business association to avoid the same subject matter from two different customers being assigned to different contract patent agents in the same business association.

9. A method as set forth in claim 1 further comprising;
assigning a filing subject matter classification number for the completed patent application (34) received from the contract patent agent,
reconciling the initial subject matter classification number to agree with the filing subject matter classification number for the completed patent application (34), and
storing the subject matter classification number for the completed patent application (34) in the contract patent agent database (36) and the customer database (28) of the computer readable memory.
